(19) United States
(12) Patent Application Publication
(10) Pub. No.: US 2024/0296374 A1
(43) Pub. Date: Sep. 5, 2024

(54) MONITORING OF EDGE- DEPLOYED MACHINE LEARNING MODELS

(71) Applicant: APPLIED MATERIALS, INC., Santa Clara, CA (US)

(72) Inventors: Joshua Shane Allen, Durham, NC (US); Michael Christopher Howells, San Jose, CA (US)

(21) Appl. No.: 18/116,772

(22) Filed: Mar. 2, 2023

(51) Int. Cl. G06N 20/00; G06F 7/24

(52) U.S. Cl. CPC G06N 20/00; G06F 7/24

(57) ABSTRACT

A method includes determining reference distribution data associated with a feature used to train a machine learning model to generate a trained machine learning model. The method further includes providing the reference distribution data to an edge device associated with substrate processing equipment. The method further includes receiving current distribution data associated with the feature from the edge device responsive to the using of the trained machine learning model at the edge device. The method further includes causing, based on the current distribution data, performance of a corrective action associated with the trained machine learning model.

### TECHNICAL FIELD

The present disclosure relates to machine learning models, more particularly, monitoring of edge-deployed machine learning models.

### BACKGROUND

Products can be produced by performing one or more manufacturing processes using manufacturing equipment. For example, substrate processing equipment can be used to produce substrates via substrate processing operations.

### SUMMARY

The following is a simplified summary of the disclosure in order to provide a basic understanding of some aspects of the disclosure. This summary is not an extensive overview of the disclosure. It is intended to neither identify key or critical elements of the disclosure, nor delineate any scope of the particular embodiments of the disclosure or any scope of the claims. Its sole purpose is to present some concepts of the disclosure in a simplified form as a prelude to the more detailed description that is presented later.

In one aspect of the present disclosure, a method includes determining reference distribution data associated with a feature used to train a machine learning model to generate a trained machine learning model. The method further includes providing the reference distribution data to an edge device associated with substrate processing equipment. The method further includes receiving current distribution data associated with the feature from the edge device responsive to the using of the trained machine learning model at the edge device. The method further includes causing, based on the current distribution data, performance of a corrective action associated with the trained machine learning model.

In another aspect of the present disclosure, a method includes receiving, from a server device, reference distribution data associated with a feature used to train a machine learning model to generate a trained machine learning model. The method further includes using the trained machine learning model based on input data associated with substrate processing equipment. The method further includes determining current distribution data associated with the feature responsive to the using of the trained machine learning model. The method further includes providing the current distribution data to the server device to cause performance of a corrective action associated with the trained machine learning model.

In another aspect of the present disclosure, a non-transitory machine-readable storage medium stores instructions. The instructions, when executed, cause a processing device to perform operations. The operations include determining reference distribution data associated with a feature used to train a machine learning model to generate a trained machine learning model. The operations further include providing the reference distribution data to an edge device associated with substrate processing equipment. The operations further include receiving current distribution data associated with the feature from the edge device responsive to the using of the trained machine learning model at the edge device. The operations further include causing, based on the current distribution data, performance of a corrective action associated with the trained machine learning model.

### BRIEF DESCRIPTION OF THE DRAWINGS

The present disclosure is illustrated by way of example, and not by way of limitation in the figures of the accompanying drawings.

FIG. 1 is a block diagram illustrating an exemplary system architecture, according to some embodiments.

FIG. 2 is a sequence diagram associated with monitoring of edge-deployed machine learning models, according to some embodiments.

FIG. 3 is a block diagram illustrating monitoring of edge-deployed machine learning models, according to some embodiments.

FIGS. 4A-B are flow diagrams of methods associated with monitoring of edge-deployed machine learning models, according to some embodiments.

FIG. 5 is a block diagram illustrating a computer system, according to some embodiments.

### DETAILED DESCRIPTION

Described herein are technologies related to monitoring of edge-deployed machine learning models (e.g., private monitoring of edge machine learning models, private and performant monitoring of edge-deployed machine learning models).

Manufacturing equipment is used to produce products. For example, substrate processing equipment is used to produce substrates (e.g., wafers, semiconductors). Substrate processing equipment is to be controlled (e.g., via selection of manufacturing parameters, etc.) to produce substrates that meet threshold values. Conventionally, trial and error is used to attempt to control substrate processing equipment to produce substrates that meet threshold values. This causes waste of materials, waste of substrates, waste of energy, waste of time, decreased yield, etc.

Once substrate processing equipment is controlled (e.g., by using particular manufacturing parameters) to produce substrates that meet threshold values, the substrate processing equipment may undergo changes (e.g., drift, becoming dirty, becoming worn down, having parts replaced, etc.) that cause the substrates produced to no longer meet threshold values. This again causes waste of materials, waste of substrates, waste of energy, waste of time, decreased yield, etc.

Machine learning models are used in various process control and predictive functions associated with manufacturing equipment. Machine learning models are trained using data associated with the manufacturing equipment. Substrate processing data is often very sensitive and is not to be shared with other devices. Conventionally, a machine learning model is trained by a server and then provided for use with substrate processing equipment via edge devices. In some conventional systems, substrate processing data used by the trained machine learning model at an edge device is not provided back to the server because of privacy concerns. In these conventional systems, the trained machine learning model at the server device and at the edge devices may not be updated based on the substrate processing data, may not be updated to accommodate drift, etc. This causes substrates to be produced that do not meet threshold values, malfunctioning of substrates, waste of substrates, decreased yield, etc.

In some conventional systems, all or a portion of the input data (e.g., sensor data) and output data (e.g., predictive data) of an edge-deployed trained machine learning model is sent to the server (e.g., server device, central server device) for monitoring of the trained machine learning model (e.g., to determine whether there is model drift). Sending data from the edge-deployed machine learning model to the server reduces privacy of the data (e.g., input and output data may be sensitive data), resulting in privacy concerns associated with the sharing of data. Sending the data of the edge-deployed machine learning model to the server may also generate a volume of data sent that may cause bandwidth shortages for edge devices, the server, and/or the overall system.

The devices, systems, and methods disclosed herein provide monitoring of edge-deployed machine learning models (e.g., private monitoring of edge machine learning models, private and performant monitoring of edge deployed machine learning models).

A system may include a server device (e.g., central server device) and one or more edge devices (e.g., edge server devices) that are each associated with a set of substrate processing equipment. In some embodiments, the server device (e.g., central server device) determines reference distribution data associated with a feature used to train a machine learning model to generate a trained machine learning model. In some embodiments, the reference distribution data includes bin ranges of training data associated with the feature, the training data being used to train the machine learning model. In some embodiments, data may have corresponding data values. In some embodiments, data is classified into sets based on the data values. For example, data may include data values ranging from 0-100. For example, the data may be classified into bin ranges 0-25, 25-50, 50-75, and 75-100. Each of 0-25, 25-50, 50-75, and 75-100 may be a corresponding bin range for sorting data. In some embodiments, the server device is further to identify the training data associated with the feature. In some embodiments, the server device is further to sort the training data into bins, wherein the determining of the reference distribution data includes determining the bin ranges of the training data sorted into the bins.

The server device provides the reference distribution data to an edge device associated with substrate processing equipment. In some embodiments, the server device may have higher computing capacities than the edge devices. In some embodiments, some data processed on the edge server may not be provided to the server device (e.g., due to privacy concerns, etc.).

The server device receives current distribution data associated with the feature from the edge device responsive to the using of the trained machine learning model at the edge device. In some embodiments, the current distribution data is based on sorting at least one of input data or predictive data into the bins (e.g., corresponding to bin ranges) via the edge device, and where the current distribution data includes counts per bin histogram data associated with the at least one of the input data or the predictive data. In some embodiments, data is classified into sets based on the data values. In some embodiments, each set can be place in a bin corresponding to the bin range of the set. For example, data may include data values ranging from 0-100. For example, the data may be classified into bin ranges 0-25, 25-50, 50-75, and 75-100. Each of 0-25, 25-50, 50-75, and 75-100 may be a bin range for sorting data and corresponds to a bin. In some embodiments, histogram data may be a diagram indicating frequency of a variable for each class interval (e.g., including rectangles whose area is proportional to the frequency of a variable and whose width is equal to the class interval). In some embodiments, counts per bin histogram data may be graphical data used to represent the frequency distribution of data points of one variable. In some embodiments, counts per bin histogram data may classify data into various bins (e.g., range groups) and count how many data points belong to each of those bins. In some embodiments, the server device is further to perform, based on the reference distribution data and the current distribution data, comparison of distributions. In some embodiments, the reference distribution data and the current distribution data are histogram data.

The server device causes, based on the current distribution data, performance of a corrective action associated with the trained machine learning model. In some embodiments, the corrective action includes at least one of providing an alert or retraining the trained machine learning model. In some embodiments, the server device is further to determine a difference between the current distribution data and the reference distribution data. In some embodiments, the server device is further to determine that the difference between the current distribution data and reference distribution data meets a threshold value, where the causing of the corrective action is responsive to the difference meeting the threshold value.

Each edge device (e.g., edge server device) may have interactions with the server device (e.g., central server device) and with a corresponding set of substrate processing equipment. In some embodiments, an edge device receives, from a server device (e.g., central server device), reference distribution data associated with a feature used to train a machine learning model to generate a trained machine learning model. In some embodiments, the reference distribution data includes bin ranges of training data associated with the feature, the training data having been used to train the machine learning model.

The edge device uses the trained machine learning model based on input data (e.g., sensor data) associated with substrate processing equipment. In some embodiments, input data may be data processed by the trained machine learning model. In some embodiments, input data may be data provided as an input to a trained machine learning model. For example, input data may be a temperature of a chamber during a processing operation. In some embodiments, the temperature input data may be used to generate a target output (e.g., predictive data) using a trained machine learning model.

The edge device determines current distribution data associated with the feature responsive to the using of the trained machine learning model. In some embodiments, the current distribution data includes bin ranges of at least one of input data or predictive data associated with the feature, the input data being used to generate the predictive data via the machine learning model. In some embodiments, the edge device is further to identify the input and predictive data associated with the feature. In some embodiments, the edge device is further to sort the at least one of input data or predictive data into bins, wherein the determining of the reference distribution data includes determining the bin ranges of the input and predictive data sorted into the bins

The edge device provides the current distribution data to the server device to cause performance of a corrective action associated with the trained machine learning model. In some embodiments, the performance of the corrective action includes at least one of causing an alert to be provided or causing the trained machine learning model to be retrained.

Aspects of the present disclosure result in technological advantages. The present disclosure avoids the privacy concerns of conventional systems associated with the sharing of data. The present disclosure further avoids causing bandwidth shortages caused by sending large amounts of data to the server device. The present disclosure further avoids producing substrates that do not meet threshold values, malfunctioning of substrates, waste of substrates, waste of materials, waste of energy, waste of time, decreased yield, etc.

Although some embodiments of the present disclosure describe edge devices associated with manufacturing systems (e.g., substrate processing equipment, manufacturing equipment, etc.) the present disclosure can be used with edge devices associated with other systems (e.g., internet of things (IoT), telecommunications, robotics, digital health, etc.).

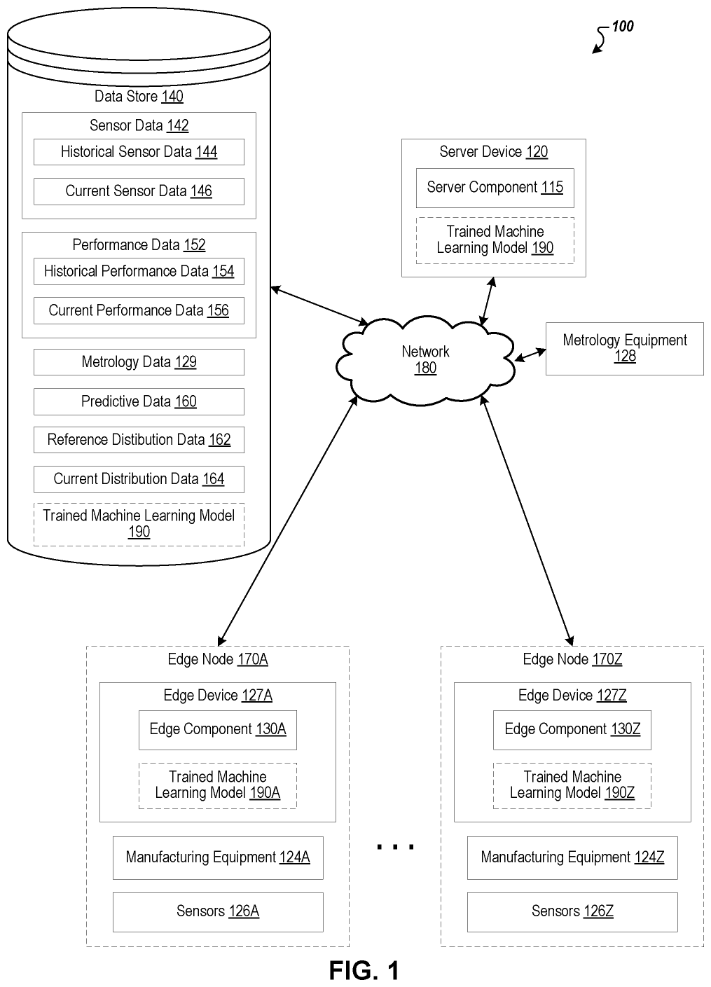

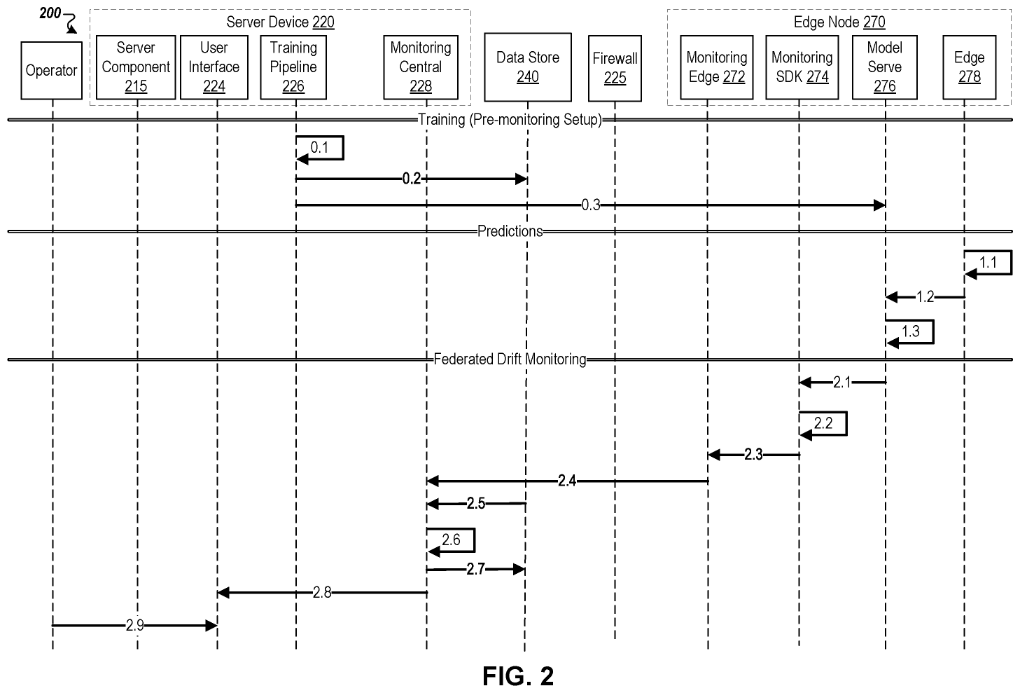

FIG. 1 depicts an illustrative computer system architecture 100, according to aspects of the present disclosure. In some embodiments, computer system architecture 100 can be included as part of a manufacturing system for processing substrates. Computer system architecture 100 includes a server device 120 (e.g., central server device), manufacturing equipment 124, sensors 126, edge nodes 170A-Z (hereinafter “edge node 170”), trained machine learning models 190A-Z (hereinafter “trained machine learning model 190”), metrology equipment 128, and a data store 140. Each edge node 170 can include an edge device 127 (e.g., including an edge component 130 and a trained machine learning model 190), manufacturing equipment 124, and sensors 126. The sensors 126 may provide sensor data associated with substrates being processed via the manufacturing equipment 124.

Manufacturing equipment 124 can produce products, such as substrates (e.g., electronic devices, wafers, semiconductors), following a recipe (e.g., performing runs over a period of time). Manufacturing equipment 124 can include a process chamber. Manufacturing equipment 124 can perform a substrate processing operation on a substrate (e.g., a wafer, etc.) at the process chamber. Examples of substrate processing operations include a deposition process to deposit one or more layers of film on a surface of the substrate, an etch process to form a pattern on the surface of the substrate, etc. Manufacturing equipment 124 can perform each process according to a process recipe. A process recipe defines a particular set of operations to be performed for the substrate during the process and can include one or more settings associated with each operation. For example, a deposition process recipe can include a temperature setting for the process chamber, a pressure setting for the process chamber, a flow rate setting for a precursor for a material included in the film deposited on the substrate surface, etc.

In some embodiments, manufacturing equipment 124 includes sensors 126 that are configured to generate data associated with a substrate processed at manufacturing system 100. For example, a process chamber can include one or more sensors configured to generate spectral or non-spectral data associated with the substrate before, during, and/or after a process (e.g., a deposition process) is performed for the substrate. In some embodiments, spectral data generated by sensors 126 can indicate a concentration of one or more materials deposited on a surface of a substrate. Sensors 126 configured to generate spectral data associated with a substrate can include reflectometry sensors, ellipsometry sensors, thermal spectra sensors, capacitive sensors, and so forth. Sensors 126 configured to generate non-spectral data associated with a substrate can include temperature sensors, pressure sensors, flow rate sensors, voltage sensors, etc.

In some embodiments, sensors 126 provide sensor data (e.g., sensor values, features, trace data, etc.) associated with manufacturing equipment 124 (e.g., associated with producing, by manufacturing equipment 124, corresponding products, such as wafers). Sensor data received over a period of time (e.g., corresponding to at least part of a recipe or run) can be referred to as trace data (e.g., historical trace data, current trace data, etc.) received from different sensors 126 over time. Sensor data can include a value of one or more of temperature (e.g., heater temperature), spacing (SP), pressure, high frequency radio frequency (HFRF), voltage of electrostatic chuck (ESC), electrical current, material flow, power, voltage, etc. Sensor data can be associated with or indicative of manufacturing parameters such as hardware parameters, such as settings or components (e.g., size, type, etc.) of the manufacturing equipment 124, or process parameters of the manufacturing equipment 124. The sensor data can be provided while the manufacturing equipment 124 is performing manufacturing processes (e.g., equipment readings when processing products). The sensor data can be different for each substrate.

In some embodiments, an edge device 127 is an edge server. Edge devices 127 can receive input data and generate predictive data 160 (e.g., by using a machine learning model, an inference engine, a heuristics model, an algorithm, a physics-based engine, etc.). In some embodiments, edge device 127 may include trained machine learning model 190.

In some embodiments, server device may train a machine learning model to generate a trained machine learning model (e.g., trained machine learning model 190). Trained machine learning model 190 may be deployed to the edge nodes 170 (e.g., edge-based models). Trained machine learning model 190 may be executed on the edge devices 127 in association with manufacturing equipment 124 (e.g., tools and/or substrate processing systems, such as platforms, transfer chambers, mainframes, factory interfaces, and/or tool clusters) instead of being executed on remote computing devices (e.g., instead of on server device 120). In some embodiments, trained machine learning model 190 may be edge-based models that execute at the edge nodes 170 rather than on remote computing devices (e.g., instead of on server device 120). Training of the machine learning models may be performed remotely (e.g., on server device 120), after which trained machine learning model 190 may be transferred to edge devices 127 or may be used on the edge devices. Retraining or updating of training of the machine learning models (e.g., trained machine learning model 190) may be performed periodically or continuously on the edge devices 127 or remotely on server device 120. By moving execution and/or training (including retraining) of the machine learning models to the edge devices systems, latency between generation of sensor data and making decisions based on the sensor data can be significantly reduced. Additionally, moving the decision making to the edge device reduces an amount of data that is transmitted over a network, increases efficiency, reduces privacy concerns, and increases a speed with which decisions can be made.

Metrology equipment 128 can provide metrology data associated with substrates processed by manufacturing equipment 124. The metrology data can include film property data (e.g., wafer spatial film properties), dimensions (e.g., thickness, height, etc.), dielectric constant, dopant concentration, density, defects, etc. In some embodiments, the metrology data can further include one or more surface profile property data (e.g., an etch rate, an etch rate uniformity, a critical dimension of one or more features included on a surface of the substrate, a critical dimension uniformity across the surface of the substrate, an edge placement error, etc.). The metrology data can be of a finished or semi-finished product. The metrology data can be different for each substrate. Metrology data can be generated using, for example, reflectometry techniques, ellipsometry techniques, transmission electron microscopy (TEM) techniques, and so forth.

Metrology equipment 128 can be included as part of the manufacturing equipment 124. For example, metrology equipment 128 can be included inside of or coupled to a process chamber and configured to generate metrology data for a substrate before, during, and/or after a process (e.g., a deposition process, an etch process, etc.) while the substrate remains in the process chamber. In some embodiments, metrology equipment 128 can be referred to as in-situ metrology equipment. In some embodiments, metrology equipment 128 can be coupled to another station of manufacturing equipment 124. For example, metrology equipment 128 can be coupled to a transfer chamber, a load lock, or a factory interface. In some embodiments, metrology equipment 128 is separate from manufacturing equipment 124 (e.g., after a substrate it processed, the substrate is transferred from the manufacturing equipment 124 to the metrology equipment 128 to produce metrology data).

Metrology equipment 128 can be included as part of edge nodes 170. For example, metrology equipment 128 can be included inside of or coupled to a process chamber and configured to generate metrology data for a substrate before, during, and/or after a process (e.g., a deposition process, an etch process, etc.) while the substrate remains in the process chamber.

Server device 120, and edge devices 127 may each include one or more computing devices such as a rackmount server, a router computer, a server computer, a personal computer, a mainframe computer, a laptop computer, a tablet computer, a desktop computer, Graphics Processing Unit (GPU), accelerator Application-Specific Integrated Circuit (ASIC) (e.g., Tensor Processing Unit (TPU)), etc. Operations of server device 120, edge devices 127, data store 140, etc., may be performed by a cloud computing service, cloud data storage service, etc.

Server device 120 may include a server component 115. In some embodiments, the server component 115 may receive current distribution data 164 (e.g., bin counts, histogram data, etc.) for performing a comparison to reference distribution data 162. Server component 115 may determine a difference (e.g., difference index, difference index value, between current distribution data 164 and reference distribution data 162. For example, server component 115 may also compare a difference index value to a threshold value to determine if the difference index value meets the threshold value. Server component 115 may further receive additional data, such as current distribution data 164 (e.g., receive from the edge device 127, retrieve from the data store 140, etc.), metrology data 129, etc., to generate a difference index (e.g., by comparison of distributions).

In some embodiments, the server component 115 may receive training data (e.g., target inputs, target outputs, etc.) for performing a bin assessment (e.g., determining bin ranges based on training data). Server component 115 may determine bin ranges of the training data. In some embodiments, server component 115 may be broken into multiple components, devices, etc. to execute the functions described as being executed by server device 120. In some embodiments, the functions described herein may all executed by one component/device (e.g., server component 115).

In some embodiments, server component 115 may train and/or retrain trained machine learning model 190.

Edge nodes 170 (e.g., edge devices 127) may be associated with one or more trained machine leaning models (e.g., trained machine learning model 190). In some embodiments, edge nodes 170 may include trained machine learning model 190. Machine learning models associated with edge nodes 170 (e.g., edge devices 127) may perform many tasks, including process control, classification, performance predictions (e.g., associated with substrate processing equipment), processing updates, etc. Trained machine learning modes (e.g., trained machine learning model 190) may be trained using data (e.g., training data) associated with manufacturing equipment 124 or products processed by manufacturing equipment 124, e.g., sensor data (e.g., collected by sensors 126), manufacturing parameters (e.g., associated with process control of manufacturing equipment 124), metrology data (e.g., generated by metrology equipment 128), etc. In some embodiments, edge devices 127 may be broken into multiple components, devices, etc. to execute the functions described as being executed by edge devices 127. In some embodiments, the functions described herein may all executed by one component/device (e.g., edge device 127).

One type of machine learning model that may be used to perform some or all of the above tasks is an artificial neural network, such as a deep neural network. Artificial neural networks generally include a feature representation component with a classifier or regression layers that map features to a desired output space. A convolutional neural network (CNN), for example, hosts multiple layers of convolutional filters. Pooling is performed, and non-linearities may be addressed, at lower layers, on top of which a multi-layer perceptron is commonly appended, mapping top layer features extracted by the convolutional layers to decisions (e.g., classification outputs).

A recurrent neural network (RNN) is another type of machine learning model. A recurrent neural network model is designed to interpret a series of inputs where inputs are intrinsically related to one another, e.g., time trace data, sequential data, etc. Output of a perceptron of an RNN is fed back into the perceptron as input, to generate the next output.

In some embodiments, trained machine learning model 190 may be at least one of a linear regression model, deep learning model, logistic regression model, decision tree model, support vector machine (SVM) algorithm model, Naive Bayes algorithm model, k-nearest neighbors (KNN) algorithm model, K-means model, random forest algorithm model, dimensionality reduction algorithm model, gradient boosting algorithm model, AdaBoosting algorithm model, and/or the like.

Server component 115 may compare distribution data and may generate a difference index value based on the comparison. The difference index value may include or indicate a level of change in the current data as compared to the reference data. In one example, the difference index value is a real number between 0 and 1 inclusive, where 0 indicates no difference between the current data and the reference data and 1 indicates that the current data is completely different than the reference data. Responsive to the difference index value indicating a level of dissimilarity above a threshold level (e.g., threshold value) server component 115 may cause a corrective action associated with the trained machine learning model 190 (e.g., providing an alert, re-training the trained machine learning model based on sensor data, metrology data, etc.). In some embodiments, retraining may include generating one or more data sets utilizing historical data and/or synthetic data.

Data store 140 can be a memory (e.g., random access memory), a drive (e.g., a hard drive, a flash drive), a database system, or another type of component or device capable of storing data. Data store 140 can include multiple storage components (e.g., multiple drives or multiple databases) that can span multiple computing devices (e.g., multiple server computers).

Data store 140 may store one or more of sensor data 142 (e.g., from sensors 126 associated with manufacturing equipment 124), metrology data 129 (e.g., from metrology equipment 128), performance data 152 (e.g., from metrology equipment 128 used to perform metrology on substrates produced via manufacturing equipment 124), predictive data 160 (e.g., predictive performance data), reference distribution data 162 (e.g., bin ranges, counts per bin, counts per bin histogram, training data sorted into bin ranges, etc.), current distribution data 164 (e.g., counts per bin, counts per bin histogram, input and predictive data sorted in bin ranges, etc.), training data, input data, trained machine learning models (e.g., trained machine learning model 190), etc. In some embodiments, performance data 152 may be data collected from metrology equipment 128 associated with substrates.

In some embodiments, input data may be current sensor data. In some embodiments, training data may be historical sensor data 144 and/or historical performance data 154. In some embodiments, predictive data 160 may be the output data of a trained machine learning model (e.g., trained machine learning model 190).

Sensor data 142 can include historical sensor data 144 and current sensor data 146. Performance data 152 can include historical performance data 154 and current performance data 156. Training data may refer to sensor data 142 and/or performance data 152 (e.g., historical sensor data 144 and historical performance data 154). For example, server component 115 of server device 120 may train a machine learning model (e.g., trained machine learning model 190) using training data (e.g., sensor data 142 and/or performance data 152, historical sensor data 144 and historical performance data 154).

The trained machine learning model (e.g., trained machine learning model 190) may then be used by edge component 130 of edge device 127. Edge component 130 may provide current sensor data 146 (e.g., from sensors 126 associated with manufacturing equipment 124 in the same edge node 170 as the edge device 127) as input to the trained machine learning model (e.g., trained machine learning model 190) and may receive output associated with predictive data 160 from the trained machine learning model. In some embodiments, trained machine learning model 190 may be part of at least one of edge node 170, edge device 127, and/or, edge component 130.

In some embodiments, server device 120 provides reference distribution data 162 (e.g., to edge device 127, to data store 140) and the edge device 127 provides current distribution data 164 (e.g., to server device 120, to data store 140). Server component 115 and/or edge component 130 can use the reference distribution data 162 and/or current distribution data 164 to determine whether to perform a corrective action (e.g., re-train the machine learning model responsive to drift and/or difference between the reference distribution data 162 and current distribution data 164).

In some embodiments, the data store 140 can store data associated with processing a substrate at manufacturing equipment 124. For example, data store 140 can store sensor data 142 collected by sensors 126 associated with manufacturing equipment 124 before, during, or after a substrate process. Sensor data 142 can refer to historical sensor data 144 (e.g., sensor data generated for a prior substrate processed at the manufacturing system or a processing chamber during a prior substrate process) and/or current sensor data 146 (e.g., sensor data generated for a current substrate processed at the manufacturing system or a processing chamber during a prior substrate process).

In some embodiments, the data store 140 can store predictive data 160 made by trained machine learning model 190 (e.g., outputs of the trained machine learning model).

In some embodiments, the data store 140 can store data associated with a substrate processed at manufacturing equipment 124. For example, data store 140 can store metrology data 129 collected by metrology equipment 128 before, during, or after a substrate process. Metrology data 129 data can refer to historical metrology data (e.g., metrology data generated for a prior substrate processed at the manufacturing system) and/or current metrology data (e.g., metrology data generated for a current substrate processed at the manufacturing system).

In some embodiments, the data store 140 can store data associated with processing a substrate at manufacturing equipment 124. For example, data store 140 can store performance data 152 collected by, for example, sensors 126 and/or metrology equipment 128 before, during, or after a substrate process. Performance data 152 can refer to historical performance data 154 (e.g., sensor data and or metrology data generated for a prior substrate processed at the manufacturing system or a processing chamber during a prior substrate process) and/or current performance data 156 (e.g., sensor data and/or metrology data generated for a current substrate processed at the manufacturing system or a processing chamber during a prior substrate process).

The data store 140 can also store distribution data. Distribution data can include bin assessments, bin ranges of training data, input data, and/or predictive data (e.g., output data). In some embodiments, bin ranges of existing training data, input data, and/or predictive data may be determined and the training data, input data, and/or predictive data may be sorted into the bins. Distribution data can be either reference distribution data or current distribution data.

Reference distribution data can be generated at the server device 120 using training data (e.g., data used to train a trained machine learning model). Current distribution data can be generated at the edge nodes 170 (e.g., by edge server) using input data and/or predictive data (e.g., output data) associated with trained machine learning model 190 (e.g., data processed by the trained machine learning model).

Reference distribution data and/or current distribution data can be histogram data. In some embodiments, histogram data may be a diagram including rectangles whose area is proportional to the frequency of a variable and whose width is equal to the class interval. In some embodiments, histogram data may be graphical data used to represent the frequency distribution of data points of one variable. In some embodiments, histograms data may classify data into various bins (e.g., range groups) and count how many data points belong to each of those bins.

In some embodiments, the server component 115 may compare distribution data (e.g., current distribution data to reference distribution data) to determine a difference (e.g., difference index value) between two or more sets of distribution data. In some embodiments, the server component 115 may compare distribution data of a certain feature to feature importance or may multiply the difference index value by the feature importance value. In some embodiments, feature importance can be an indicator of the importance of a feature in training a trained machine learning model (e.g., trained machine learning model 190) and can indicate how important a certain feature is to the accuracy of the trained machine learning model.

In some embodiments, the feature importance value may include or indicate a level of relevancy of a certain feature to operation of trained machine learning model 190. In some embodiments, the feature importance value is a real number between 0 and 1 inclusive, where 0 indicates the feature has no relationship to or no impact on the accurate operation of trained machine learning model 190 and 1 indicates that has an absolute relationship or direct impact on the accurate operation of trained machine learning model 190.

In some embodiments, the feature importance value may be identified by user input, a machine learning model, etc.

In some embodiments, data store 140 can be configured to store data that is not accessible to a user of the manufacturing equipment 124 and/or edge node 170. For example, sensor data 142, performance data 152, predictive data 160, reference distribution data, current distribution data, and/or the like may not be accessible to a user (e.g., an operator) of the manufacturing equipment 124. In some embodiments, all data stored at data store 140 may be inaccessible by the user of the manufacturing equipment 124 and/or edge node 170. In other or similar embodiments, a portion of data stored at data store 140 can be inaccessible by the user while another portion of data stored at data store 140 can be accessible by the user. In some embodiments, one or more portions of data stored at data store 140 can be encrypted using an encryption mechanism that is unknown to the user (e.g., data is encrypted using a private encryption key). In other or similar embodiments, data store 140 can include multiple data stores where data that is inaccessible to the user is stored in one or more first data stores and data that is accessible to the user is stored in one or more second data stores.

In some embodiments, sensor data 142, historical sensor data 144, current sensor data 146, performance data 152, historical performance data 154, current performance data 156, predictive data 160, reference distribution data 162, and/or current distribution data 164, may be processed by the server device 120, training data, input data, and/or by the edge device 127. Processing of the data may include generating features. In some embodiments, the features are a pattern in the training data, input data, predictive data 160, reference distribution data 162, and/or current distribution data 164 (e.g., slope, width, height, peak, etc.) or a combination of values from the training data, input data, predictive data 160, reference distribution data 162, and/or current distribution data 164, (e.g., power derived from voltage and current, etc.). Data may include features and the features may be used by server device 120 for determining feature importance and/or for causing performance of a corrective action.

In some embodiments, a feature may be a type of sensor data (e.g., temperature, pressure, humidity). For example, a feature could be a combination of sensor data (e.g., power calculated from current and voltage). In some embodiments, a feature may be a pattern in sensor data (e.g., slope, etc.). In some embodiments, a feature may be a type of metrology data (e.g., morphology, size attribute, dimensional attribute, images, scanning electron microscope (SEM) images, energy dispersive x-ray (EDX) images, defect distribution, spatial location, elemental analysis, wafer signature, chip layer, chip layout, grey level, signal to noise, spacing, etc.) For example, a feature could be a combination of metrology data. In some embodiments, a feature may be a pattern in metrology data.

The server device 120, edge devices 127, metrology equipment 128, and data store 140 can be coupled to each other via a network 180. In some embodiments, network 180 is a public network that provides server device 120 with access to manufacturing equipment 124, data store 140, and other publicly available computing devices. In some embodiments, network 180 is a private network that provides server device 120 access to manufacturing equipment 124, metrology equipment 128, data store 140, and other privately available computing devices. Network 180 can include one or more wide area networks (WANs), local area networks (LANs), wired networks (e.g., Ethernet network), wireless networks (e.g., an 802.11 network or a Wi-Fi network), cellular networks (e.g., a Long Term Evolution (LTE) network), routers, hubs, switches, server computers, cloud computing networks, and/or a combination thereof.

In some embodiments, server component 115 receives an indication of a corrective action from the server device 120 and causes the corrective action to be implemented. Server device 120 may include an operating system that allows users to one or more of generate, view, or edit data (e.g., indication associated with trained machine learning model, indication associated with manufacturing equipment 124, corrective actions associated with trained machine learning model 190, corrective action associated with manufacturing equipment 124, etc.).

Corrective actions may be associated with one or more of Computational Process Control (CPC), Statistical Process Control (SPC) (e.g., SPC on electronic components to determine process in control, SPC to predict useful lifespan of components, SPC to compare to a graph of 3-sigma, etc.), Advanced Process Control (APC), model-based process control, preventative operative maintenance, design optimization, updating of manufacturing parameters, updating manufacturing recipes, updating of equipment constants, feedback control, feedforward control, machine learning modification, or the like.

In some embodiments, the corrective action includes providing an alert (e.g., an alert indicating a recommended action, such as re-training a trained machine learning model; an alarm to stop or not perform the manufacturing process if model drift meets a threshold value). In some embodiments, performance of a corrective action may include retraining a machine learning model associated with manufacturing equipment 124 and/or deployed on an edge device (e.g., run on an edge server). In some embodiments, performance of a corrective action may include training a new machine learning model associated with manufacturing equipment 124.

In some embodiments, the functions of server device 120 and edge devices 127 may be provided by a fewer number of machines. In some embodiments, server device 120 and edge devices 127 may be integrated into a single machine. In some embodiments, functions of server device 120, edge devices 127, and data store 140 may be performed by a cloud-based service.

In general, functions described in some embodiments as being performed by server device 120 can also be performed on edge devices 127 in other embodiments, if appropriate. In general, functions described in some embodiments as being performed by edge devices 127 can also be performed on server device 120 in other embodiments, if appropriate. In addition, the functionality attributed to a particular component can be performed by different or multiple components operating together. For example, in some embodiments, the edge devices 127 may determine the corrective action based on the difference index value. In another example, server device 120 may determine the corrective action based on the current distribution data 164 of trained machine learning model 190.

In addition, the functions of a particular component can be performed by different or multiple components operating together. One or more of the server device 120, or edge devices 127 may be accessed as a service provided to other systems or devices through appropriate application programming interfaces (API).

In some embodiments, machine learning models (e.g., trained machine learning models 190) may be trained at a server device 120 (e.g., central server) and be deployed by an edge device 127 (e.g., associated with edge tools of a manufacturing system). The server device 120 may have a greater computing capacity than an edge device 127 (e.g., server device 120 may have considerable computing power while the edge device 127 may have comparatively limited computing power). Processing recipes include parameters selected to generate a processing outcome, e.g., to enable processing of a substrate characterized by one or more target properties. Processing recipes may include parameters selected and/or adjusted based on product design, target output, target substrate metrology, etc. Processing recipes may include parameters such as processing temperature, processing pressure, processing gas, radio frequency (RF) radiation properties, plasma properties, etc.

During use, a relationship between the output and input variables (e.g., input data, output data) of a trained machine learning model (e.g., trained machine learning model 190) may change (drift) causing the trained machine learning model to drift (model drift). For example, a machine learning model may have been trained with training data within a certain range of values. Subsequently, the trained machine learning model may be deployed and used to process data outside of the range of the training data. Input drift may cause the outputs (e.g., predictions) of the machine learning model to drift causing model drift. Predictions of a trained machine learning model may also drift, indicating that the relationship between the output and input variables of the trained machine learning model has drifted.

In some embodiments, trained machine learning models may be deployed to edge devices and may be monitored by a server device (e.g., a central server device). In some embodiments, this configuration may be referred to as distributed monitoring of machine learning models.

In embodiments, a “user” can be represented as a single individual. However, other embodiments of the disclosure encompass a “user” being an entity controlled by a plurality of users and/or an automated source. For example, a set of individual users federated as a group of administrators can be considered a “user.”

FIG. 2 is a sequence diagram 200 associated with monitoring of edge-deployed machine learning models, according to some embodiments. FIG. 2 illustrates monitoring trained machine learning models deployed on the edge, while maintaining privacy and performance. In some embodiments, the system includes an operator, server device 220 (e.g., server device 120 of FIG. 1), data store 240, firewall 225 (e.g., deployed by server device 220, deployed by an additional device), and/or edge node 270 (e.g., edge node 170 or edge device 127 of FIG. 1).

Server device 220 may include one or more of a user interface 224, a training pipeline 226, and/or a monitoring central 228. One or more of user interface 224, training pipeline 226, and/or monitoring central 228 may be part of server component 115 of FIG. 1.

Edge node 270 may include one or more of monitoring edge 272, monitoring software development kit (SDK) 274, model serve 276, and/or edge 278 (e.g., edge nodes 170, edge devices 127, etc.). One or more of monitoring edge 272, monitoring SDK 274, model serve 276, and/or edge 278 may be part of edge component 130 of FIG. 1.

In some embodiments, operations 0.1-0.3 may be part of a training phase (e.g., pre-monitoring setup). At operation 0.1, server device 220 (e.g., via training pipeline) may determine reference distribution data (e.g., reference distribution data 162 of FIG. 1) associated with a feature used to train a machine learning model to generate a trained machine learning model (e.g., trained machine learning model 190). This may include, after training a machine learning model (e.g., trained machine learning model 190) using training data including inputs X and outputs Y, where X may be the list of features (e.g., inputs) and Y may the dependent variable (e.g., outputs), the server device 220 may compute a list of bins to describe the distribution of each feature in X and for Y. The server device may further compute the reference distributions of the data X and Y using the bins (e.g., sort the data X and Y into the bins, such as drift bins). The server device 220 may further calculate the feature importance using Shapley additive explanations (SHAP) and/or the like.

At operation 0.2, server device 220 (e.g., via training pipeline) may provide the reference distribution data from operation 0.1 to data store 240 (e.g., data store 140 of FIG. 1). In some embodiments, server device 220 further provides feature importance data and drift bins to the data store 240.

At operation 0.3, the server device 220 may send (e.g., via server component 215) reference distribution data (e.g., the list of bins calculated in operation 0.1) to each edge node 270 (e.g., edge nodes 170 of FIG. 1) running the trained machine learning model (e.g., trained machine learning model 190). In some embodiments, each edge node 270 retrieves the reference distribution data from the data store 240. Any data provided to or received from the edge node 270 may pass through firewall 225 (e.g., to avoid privacy concerns).

Operations 1.1-1.3 may be part of a predictions phase (e.g., using trained machine learning model 190 on edge devices). At operation 1.1, edge node 270 (e.g., via an edge device 127 of FIG. 1) identifies (e.g., receives) sensor data (e.g., from sensors associated with manufacturing equipment). The edge node 270 may determine, based on the sensor data, features (e.g., inputs, input data) to make a prediction associated with the substrate processing equipment (e.g., generate predictive data 160, outputs).

At operation 1.2, the edge node 270 provides the input data (e.g., sensor data, features) to the trained machine learning model (e.g., trained machine learning model 190). In some embodiments, the edge 278 provides the input data to the model serve to invoke prediction.

At operation 1.3, the edge node 270 (e.g., via model serve) generates output data associated with predictive data (e.g., predictive data 160 of FIG. 1, predictive performance data, using the features from operation 1.2.).

Operations 2.1-2.9 may be part of a federated drift monitoring phase. At operation 2.1, the edge node 270 (e.g., via model serve 276) sends the features and predictions (e.g., predictive data 160 of FIG. 1, output of the trained machine learning model) to the monitoring SDK 274 of the edge node 270.

At operation 2.2, the edge node 270 (e.g., via monitoring SDK 274) determines current distribution data (e.g., current distribution data 164 of FIG. 1, calculates bin counts). The edge node 270 may use the bins received in operation 0.3 to generate histogram data (e.g., bin counts, current distribution data) of each feature and prediction (e.g., predictive data 160 of FIG. 1). For example, each histogram data may reflect the distribution of data.

At operation 2.3, the edge node 270 (e.g., via monitoring SDK 274) may send the current distribution data (e.g., current distribution data 164 of FIG. 1, histogram data) to a monitoring agent (e.g., monitoring edge 272 of edge node 270). The current distribution data (e.g., histogram data) may be maintained over a period of time as more predictive data is generated via the trained machine learning model (e.g., trained machine learning model 190) at the edge node 270.

At operation 2.4, edge node 270 (e.g., via a monitoring agent upon reaching a threshold of data, each monitoring agent running on an edge device) may send the current distribution data (e.g., histogram data) to the server device 220 (e.g., monitoring central 228 on the server device). In some embodiments, the current distribution data is provided from the edge node 270 to the data store 240 and the server device 220 retrieves the current distribution data from the data store 240.

At operation 2.5, server device (e.g., monitoring central 228) may obtain the reference distributions and feature importance data from the data store 240.

At operation 2.6, monitoring central 228 may calculate the model drift of the current data distribution compared to the reference distribution data for each feature and prediction. Calculating model drift may use a common algorithmic approach, such as population stability index (PSI), and/or the like. The server device (e.g., via monitoring central 228) may also multiply the feature importance values by the drift results (drift index) to determine how each feature drift impacts the overall model performance (e.g., drift values for certain features may not have the same impact on model performance as other features).

At operation 2.7, the server device 220 (e.g., via monitoring central 228) may store the drift results (e.g., difference index, drift index value) in the data store 240.

At operation 2.8, responsive to one or more drift values (e.g., difference index, drift index value) exceeding a threshold value, an alert may be sent to user interface 224 or other notification mechanism.

At operation 2.9, an operator may view the alert via the user interface 224.

In some embodiments, privacy of data is maintained by sending summary statistics (e.g., bin counts, histogram data, etc.) from the edge node 270 (e.g., edge device) to the server device 220. In some embodiments, features and/or raw data is maintained at the edge node 270 and is not sent to the server device 220. In some embodiments, sending only small amounts of data (e.g., bin counts, histogram data, etc.) between the server device and edge devices causes better performance.

In some embodiments, monitoring SDK 274 and the monitoring agent (e.g., monitoring edge 272) running on the edge node 270 (e.g., edge device) have minimal system overhead. In some embodiments, the monitoring SDK 274 and monitoring agent running on the edge node 270 may sort data into bins and transmit summary statistics (e.g., histograms, distribution data, etc.). In some embodiments, the monitoring SDK 274 can run in the same memory space as the model serve 276 that already has the features and prediction in memory, eliminating the need send or transmit that data outside the process memory space where it already resides.

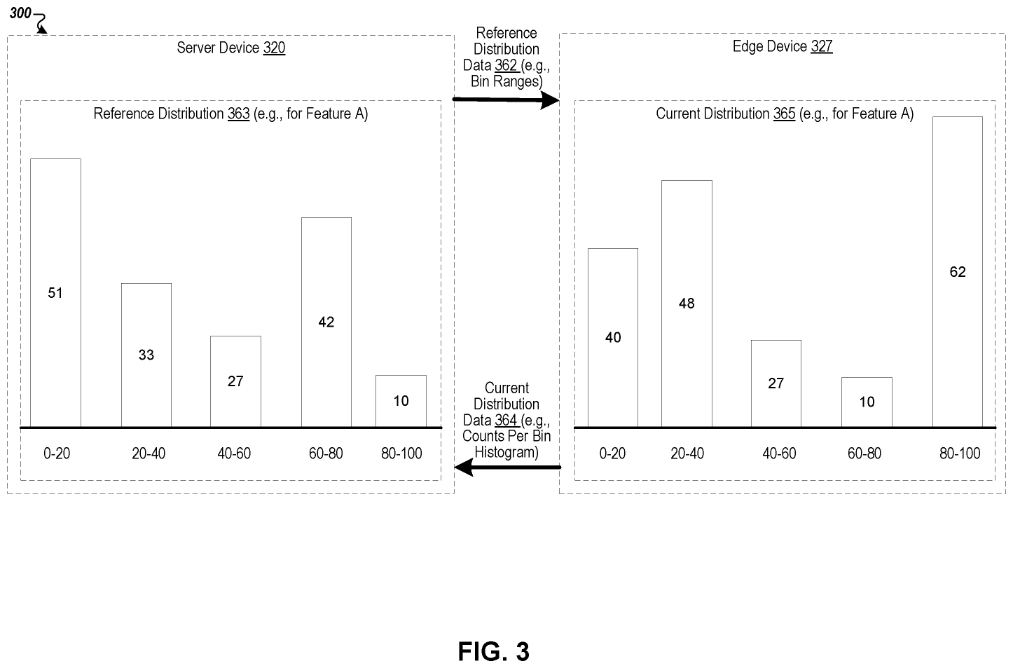

FIG. 3 depicts a block diagram 300 associated with monitoring of edge-deployed machine learning models, according to some embodiments.

In some embodiments, a server device (e.g., server device 120) determines reference distribution 363 (e.g., reference distribution graph) associated with input data (e.g., sensor data) and/or target output data (e.g., performance data, metrology data) used to train a machine learning model. In some embodiments, reference distribution 363 may correspond to a feature of the input data and/or the target output data. In some embodiments, the server device 220 determines reference distribution data 362 (e.g., bin ranges) based on the reference distribution 363 (e.g., of feature A) and provides the reference distribution data 362 (e.g., bin ranges) to the edge device 327 (e.g., edge device 127 of FIG. 1).

In some embodiments, reference distribution data 362 may be derived from or may be a subset of reference distribution 363. For example, reference distribution data 362 may include only a portion of reference distribution 363. For example reference distribution data 362 may include only bin ranges and not counts per bin included in reference distribution 363.

In some embodiments, current distribution data 364 may be derived from or may be a subset of current distribution 365. For example, current distribution data 364 may include only a portion of current distribution 365. For example current distribution data 364 may include only counts per bin and not individual data point values included in current distribution 365.

In some embodiments, the edge device 327 determines current distribution 365 (e.g., current distribution graph) by sorting input data (e.g., sensor data) provided as input to the trained machine learning model (e.g., trained machine learning model 190) at the edge device 327 associated with the feature and/or predictions (e.g., predictive data associated with output of the trained machine learning model (e.g., trained machine learning model 190) at the edge device 127 responsive to inputting the input) into the correspond bin ranges provided by the server device 320. For example, bin ranges may include a range from 0-20, 20-40, 40-60, 60-80, and 80-100. The server device 320 may sort feature A data (e.g., training data) into the bins corresponding to the ranges. The server device 320 may send the bin ranges to the edge device 327 where the trained machine learning model corresponding to the reference distribution 363 is deployed.

In some embodiments, the edge device 327 sorts the input and/or predictive (output) data of the trained machine learning model (e.g., trained machine learning model 190) into the bins corresponding to the bin ranges of the reference distribution data 362 to generate current distribution data 364 (e.g., counts per bin histogram). In some embodiments, a count or count per bin (e.g., bin assessments) may be determined for each bin. In some embodiments, the edge device 327 sends the current distribution data 364 (e.g., counts per bin histogram) to the server device 320. In some embodiments, the server device 320 compares the current distribution data 364 to the reference distribution data 362 to determine a difference between the two data sets. In some embodiments, the difference between the current distribution data 364 and the reference distribution data 362 may be expressed as a difference index or a difference index value. For example, a difference index value may be expressed as a decimal value between 0 and 1. In some embodiments, the difference index value may be multiplied by a feature importance value to scale the difference index value before comparing the difference index value with a threshold value. In some embodiments, responsive to the difference index value and/or the current distribution data 364 meeting a threshold value, the server device 320 may cause performance of a corrective action.

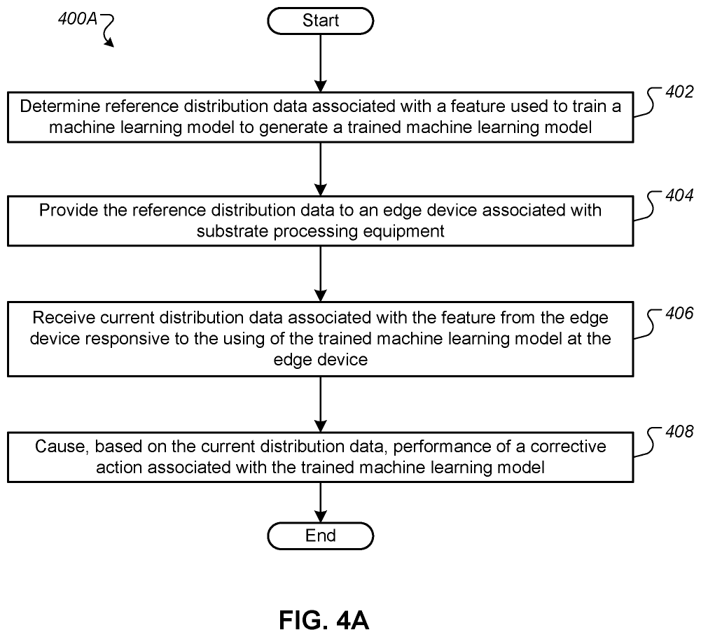

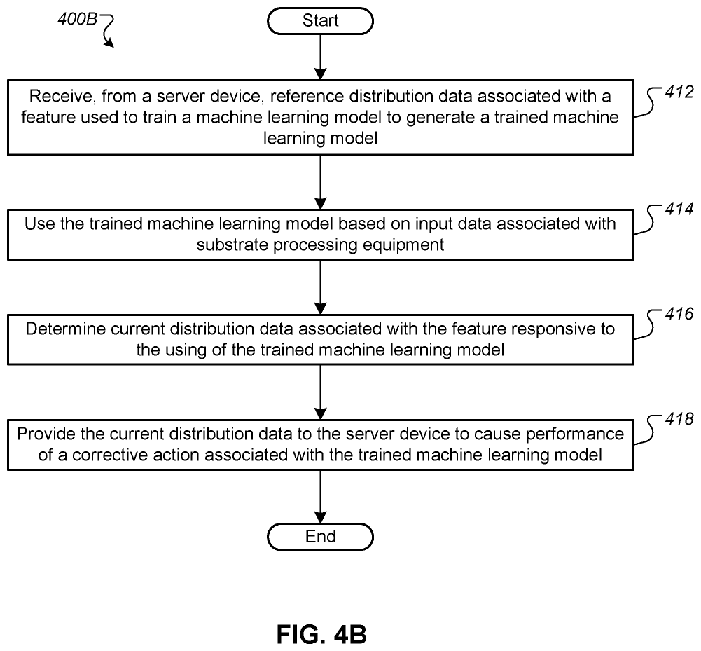

FIGS. 4A-B are flow diagrams of methods 400A-B associated with monitoring of edge-deployed machine learning models, according to certain embodiments. Methods 400A-B may be associated with training and utilizing machine learning models, statistical models, rule-based models, heuristic models, physics-based models, etc. Methods 400A-B may be performed by processing logic that may include hardware (e.g., circuitry, dedicated logic, programmable logic, microcode, processing device, etc.), software (such as instructions run on a processing device, a general purpose computer system, or a dedicated machine), firmware, microcode, or a combination thereof. In some embodiments, a non-transitory machine-readable storage medium stores instructions that when executed by a processing device cause the processing device to perform one or more of Methods 400A-B. In some embodiments, a system (e.g., server device 120 or edge device 127 of FIG. 1) includes memory and a processing device coupled to the memory to perform one or more of methods 400A-B.

For simplicity of explanation, Methods 400A-B are depicted and described as a series of operations. However, operations in accordance with this disclosure can occur in various orders and/or concurrently and with other operations not presented and described herein. Furthermore, not all illustrated operations may be performed to implement Methods 400A-B in accordance with the disclosed subject matter. In addition, those skilled in the art will understand and appreciate that Methods 400A-B could alternatively be represented as a series of interrelated states via a state diagram or events.

FIG. 4A is a flow diagram of a method 400A for private monitoring of edge machine learning models, according to some embodiments.

Referring to FIG. 4A, in some embodiments, at block 402 the processing logic (e.g., at server device 120 of FIG. 1) implementing method 400A determines reference distribution data associated with a feature used to train a machine learning model to generate a trained machine learning model (e.g., trained machine learning model 190). The trained machine learning model may have been trained using data input of historical sensor data and target output of historical performance data.

In some embodiments, the reference distribution data may include bin ranges of training data (e.g., historical sensor data and historical performance data) associated with the feature, the training data being used to train the machine learning model.

At block 404, the processing logic provides the reference distribution data to an edge device associated with substrate processing equipment.

At block 406, the processing logic receives current distribution data associated with the feature from the edge device responsive to the using of the trained machine learning model (e.g., trained machine learning model 190) at the edge device. Using of the trained machine learning model may include providing current sensor data to the trained machine learning model and receiving output associated with predictive data from the trained machine learning model.

In some embodiments, the current distribution data may be based on sorting at least one of input data (e.g., current sensor data) or predictive data (e.g., predictive performance data) into the bins via the edge device. In some embodiments, the current distribution data may include counts per bin histogram data associated with the at least one of the input data or the predictive data.

At block 408, the processing logic causes, based on the current distribution data, performance of a corrective action associated with the trained machine learning model.

In some embodiments, the corrective action may include at least one of providing an alert or retraining the trained machine learning model. In some embodiments, the processing logic further performs, based on the reference distribution data and the current distribution data, comparison of distributions. In some embodiments, the reference distribution data and the current distribution data are histogram data.

In some embodiments, the processing logic may further identify the training data associated with the feature. In some embodiments, the processing logic may further sort the training data into bins, where the determining of the reference distribution data includes determining the bin ranges of the training data sorted into the bins.

In some embodiments, the processing logic may further determine a difference (e.g., difference index) between the current distribution data and the reference distribution data. In some embodiments, the processing logic may further determine that the difference between the current distribution data and reference distribution data meets a threshold value, where the causing of the corrective action is responsive to the difference meeting the threshold value.

In some embodiments, determining a difference between the current distribution data and the reference distribution data may use a common algorithmic approach, such as population stability index (PSI), and/or the like. In some embodiments, determining a difference between the current distribution data and the reference distribution data may include multiplying the feature importance values by the difference. In some embodiments, such multiplication by the feature importance may weight a difference index value before it is compared to the threshold value. In some embodiments, such weighting of difference index values may assure that a model is not re-trained unnecessarily (e.g., when a feature is of low importance).

FIG. 4B is a flow diagram of a method 400B for private monitoring of edge machine learning models, according to some embodiments.

Referring to FIG. 4B, in some embodiments, at block 412 the processing logic (e.g., of edge device 127 of FIG. 1) implementing method 400B receives, from a server device (e.g., server device 120 of FIG. 1), reference distribution data associated with a feature used to train a machine learning model to generate a trained machine learning model (e.g., trained with data input including historical sensor data and target output including historical performance data).

In some embodiments, the reference distribution data may include bin ranges of training data (e.g., historical sensor data and/or historical performance data) associated with the feature, the training data having been used to train the machine learning model.

At block 414, the processing logic uses the trained machine learning model based on input data (e.g., current sensor data) associated with substrate processing equipment.

At block 416, the processing logic determines current distribution data associated with the feature responsive to the using of the trained machine learning model.

In some embodiments, the current distribution data may include bin ranges of at least one of input data (e.g., current sensor data) or predictive data (e.g., predictive performance data) associated with the feature, the input data being used to generate the predictive data via the machine learning model. In some embodiments, the processing logic may further identify the input and predictive data associated with the feature. In some embodiments, the processing logic may further sort the at least one of input data or predictive data into bins, where the determining of the reference distribution data includes determining the bin ranges of the input and predictive data sorted into the bins.

At block 418, the processing logic provides the current distribution data to the server device to cause performance of a corrective action associated with the trained machine learning model.

In some embodiments, the performance of the corrective action may include at least one of causing an alert to be provided or causing the trained machine learning model to be retrained.

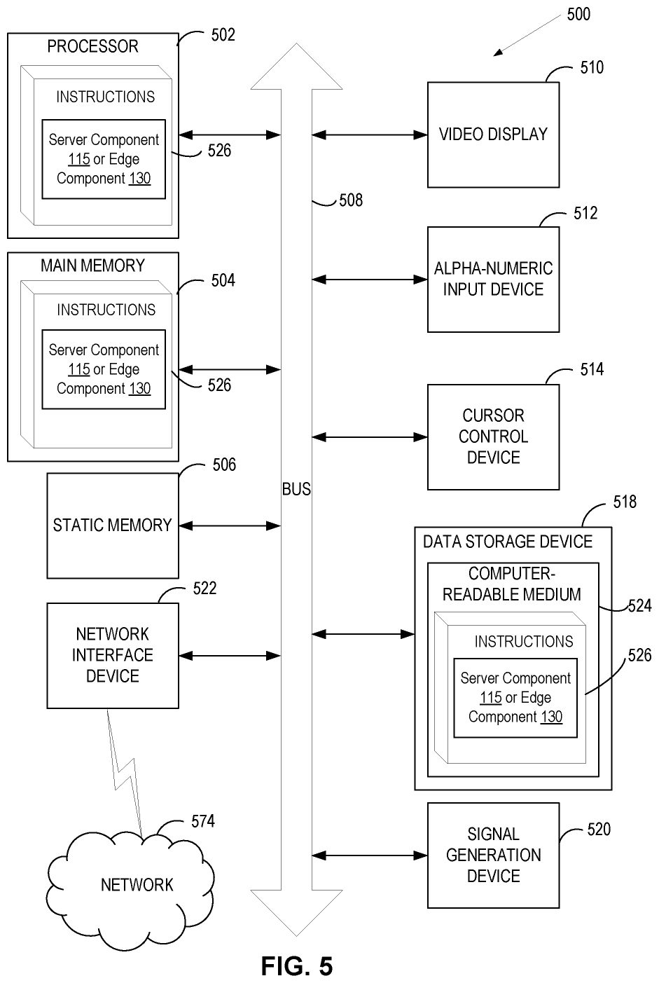

FIG. 5 is a block diagram illustrating a computer system 500, according to certain embodiments. In some embodiments, the computer system 500 is one or more of server device 120, edge device 127, and/or the like.

In some embodiments, computer system 500 is connected (e.g., via a network, such as a Local Area Network (LAN), an intranet, an extranet, or the Internet) to other computer systems. In some embodiments, computer system 500 operates in the capacity of a server or a client computer in a client-server environment, or as a peer computer in a peer-to-peer or distributed network environment. In some embodiments, computer system 500 is provided by a personal computer (PC), a tablet PC, a Set-Top Box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 500 includes a processing device 502, a volatile memory 504 (e.g., Random Access Memory (RAM)), a non-volatile memory 506 (e.g., Read-Only Memory (ROM) or Electrically-Erasable Programmable ROM (EEPROM)), and a data storage device 518, which communicate with each other via a bus 508.

In some embodiments, processing device 502 is provided by one or more processors such as a general purpose processor (such as, for example, a Complex Instruction Set Computing (CISC) microprocessor, a Reduced Instruction Set Computing (RISC) microprocessor, a Very Long Instruction Word (VLIW) microprocessor, a microprocessor implementing other types of instruction sets, or a microprocessor implementing a combination of types of instruction sets) or a specialized processor (such as, for example, an Application Specific Integrated Circuit (ASIC), a Field Programmable Gate Array (FPGA), a Digital Signal Processor (DSP), or a network processor).

In some embodiments, computer system 500 further includes a network interface device 522 (e.g., coupled to network 574). In some embodiments, computer system 500 also includes a video display unit 510 (e.g., a liquid crystal display (LCD)), an alphanumeric input device 512 (e.g., a keyboard), a cursor control device 514 (e.g., a mouse), and a signal generation device 520.

In some implementations, data storage device 518 includes a non-transitory computer-readable storage medium 524 on which store instructions 526 encoding any one or more of the methods or functions described herein, including instructions encoding components of FIG. 1 (e.g., server component 115, edge component 130, etc.) and for implementing methods described herein (e.g., one or more of methods 400A-B).

In some embodiments, instructions 526 also reside, completely or partially, within volatile memory 504 and/or within processing device 502 during execution thereof by computer system 500, hence, in some embodiments, volatile memory 504 and processing device 502 also constitute machine-readable storage media.

While computer-readable storage medium 524 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

The methods, components, and features described herein can be implemented by discrete hardware components or can be integrated in the functionality of other hardware components such as application specific integrated circuits (ASICS), FPGAS, DSPs or similar devices. In addition, the methods, components, and features can be implemented by firmware modules or functional circuitry within hardware devices. Further, the methods, components, and features can be implemented in any combination of hardware devices and computer program components, or in computer programs.

Unless specifically stated otherwise, terms such as “determining,” “providing,” “receiving,” “causing,” “identifying,” “sorting,” “performing,” “using,” “retraining,” “obtaining,” “accessing,” “adding,” “training,” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. Also, the terms “first,” “second,” “third,” “fourth,” etc. as used herein are meant as labels to distinguish among different elements and cannot have an ordinal meaning according to their numerical designation.

Examples described herein also relate to an apparatus for performing the methods described herein. This apparatus can be specially constructed for performing the methods described herein, or it can include a general purpose computer system selectively programmed by a computer program stored in the computer system. Such a computer program can be stored in a computer-readable tangible storage medium.

The methods and illustrative examples described herein are not inherently related to any particular computer or other apparatus. Various general purpose systems can be used in accordance with the teachings described herein, or it can prove convenient to construct more specialized apparatus to perform methods described herein and/or each of their individual functions, routines, subroutines, or operations. Examples of the structure for a variety of these systems are set forth in the description above.

The above description is intended to be illustrative, and not restrictive. Although the present disclosure has been described with references to specific illustrative examples and implementations, it will be recognized that the present disclosure is not limited to the examples and implementations described. The scope of the disclosure should be determined with reference to the following claims, along with the full scope of equivalents to which the claims are entitled.

1. A method comprising:
determining reference distribution data associated with a feature used to train a machine learning model to generate a trained machine learning model;
providing the reference distribution data to an edge device associated with substrate processing equipment;
receiving current distribution data associated with the feature from the edge device responsive to the using of the trained machine learning model at the edge device; and
causing, based on the current distribution data, performance of a corrective action associated with the trained machine learning model.

2. The method of claim 1, wherein the corrective action comprises at least one of providing an alert or retraining the trained machine learning model.

3. The method of claim 1, wherein the reference distribution data comprises bin ranges of training data associated with the feature, the training data being used to train the machine learning model.

4. The method of claim 3 further comprising:
identifying the training data associated with the feature; and
sorting the training data into bins, wherein the determining of the reference distribution data comprises determining the bin ranges of the training data sorted into the bins.

5. The method of claim 1 further comprising:
determining a difference between the current distribution data and the reference distribution data; and
determining that the difference between the current distribution data and the reference distribution data meets a threshold value, wherein the causing of the corrective action is responsive to the difference meeting the threshold value.

6. The method of claim 4, wherein the current distribution data is based on sorting at least one of input data or predictive data into the bins via the edge device, and wherein the current distribution data comprises counts per bin histogram data associated with the at least one of the input data or the predictive data.

7. The method of claim 1 further comprising performing, based on the reference distribution data and the current distribution data, comparison of distributions.

8. The method of claim 1, wherein the reference distribution data and the current distribution data are histogram data.

9. A method comprising:
receiving, from a server device, reference distribution data associated with a feature used to train a machine learning model to generate a trained machine learning model;
using the trained machine learning model based on input data associated with substrate processing equipment;
determining current distribution data associated with the feature responsive to the using of the trained machine learning model; and
providing the current distribution data to the server device to cause performance of a corrective action associated with the trained machine learning model.

10. The method of claim 9, wherein the performance of the corrective action comprises at least one of causing an alert to be provided or causing the trained machine learning model to be retrained.

11. The method of claim 10, wherein the reference distribution data comprises bin ranges of training data associated with the feature, the training data having been used to train the machine learning model.

12. The method of claim 11, wherein the current distribution data comprises bin ranges of at least one of input data or predictive data associated with the feature, the input data being used to generate the predictive data via the machine learning model.

13. The method of claim 12, further comprising:
identifying the input and predictive data associated with the feature; and
sorting the at least one of input data or predictive data into bins, wherein the determining of the reference distribution data comprises determining the bin ranges of the input and predictive data sorted into the bins.

14. A non-transitory machine-readable storage medium storing instructions which, when executed, cause a processing device to perform operations comprising:
determining reference distribution data associated with a feature used to train a machine learning model to generate a trained machine learning model;
providing the reference distribution data to an edge device associated with substrate processing equipment;
receiving current distribution data associated with the feature from the edge device responsive to the using of the trained machine learning model at the edge device; and
causing, based on the current distribution data, performance of a corrective action associated with the trained machine learning model.

15. The non-transitory machine-readable storage medium of claim 14, wherein the corrective action comprises at least one of providing an alert or retraining the trained machine learning model.

16. The non-transitory machine-readable storage medium of claim 14, wherein the reference distribution data comprises bin ranges of training data associated with the feature, the training data being used to train the machine learning model.

17. The non-transitory machine-readable storage medium of claim 16, wherein the operations further comprise:
identifying the training data associated with the feature; and
sorting the training data into bins, wherein the determining of the reference distribution data comprises determining the bin ranges of the training data sorted into the bins.

18. The non-transitory machine-readable storage medium of claim 14, wherein the operations further comprise:
determining a difference between the current distribution data and the reference distribution data; and
determining that the difference between the current distribution data and reference distribution data meets a threshold value, wherein the causing of the corrective action is responsive to the difference meeting the threshold value.

19. The non-transitory machine-readable storage medium of claim 17, wherein the current distribution data is based on sorting at least one of input data or predictive data into the bins via the edge device, and wherein the current distribution data comprises counts per bin histogram data.

20. The non-transitory machine-readable storage medium of claim 14, further comprising performing, based on the reference distribution data and the current distribution data, comparison of distributions.
